(19) United States
(12) Patent Application Publication
(10) Pub. No.: US 2026/0003548 A1
(43) Pub. Date: Jan. 1, 2026

(54) NON-TRANSITORY COMPUTER-READABLE STORAGE MEDIUM STORING SUPPORTING PROGRAM

(71) Applicant: BROTHER KOGYO KABUSHIKI KAISHA, Nagoya (JP)

(72) Inventors: Yushi ICHIKAWA, Nagoya (JP); Kenju NARITA, Nagoya (JP); Yoshito HOSOMIZO, Konan (JP); Airi EGUCHI, Ichinomiya (JP)

(21) Appl. No.: 19/318,014

(22) Filed: Sep. 3, 2025

Related U.S. Application Data
(63) Continuation of application No. PCT/JP2024/007007, filed on Feb. 27, 2024.

(30) Foreign Application Priority Data
Mar. 3, 2023 (JP) 2023-032460

(51) Int. Cl. G06F 3/12

(52) U.S. Cl. CPC G06F 3/1205; G06F 3/1228; G06F 3/1253

(57) ABSTRACT

A non-transitory computer-readable storage medium stores a supporting program executable by a computer of an information processing apparatus. The supporting program causes the computer to perform operations including: determining whether a printer connected to the apparatus supports printing on roll media in response to receiving a specified instruction from a universal printing program included in an operating system of the apparatus; in response to determining that the printer supports roll media, causing a user interface of the apparatus to display a settings screen that accepts the setting of specific parameters for printing on roll media; and in a case where, in response to a print instruction being issued, image data according to the print instruction is input from the operating system, and the parameters are set on the setting screen, causing the printer to print on roll media based on the image data and in accordance with the parameters.

### REFERENCE TO RELATED APPLICATIONS

This is a continuation application of International Application No. PCT/JP2024/007007 filed on February 27, 2024, which claims priority from Japanese Patent Application No. 2023- 032460 filed on March 3, 2023. The entire contents of the aforementioned applications are incorporated herein by reference.

### BACKGROUND ART

Technologies are known for controlling printers capable of printing on roll media, which is a band-shaped print medium, from information processing apparatuses such as personal computers (PCs). For example, a known printer driver provided by a printer vendor controls a printer capable of printing on roll media and causes a computer to generate print instruction data.

### SUMMARY

In recent years, a technology has been commercialized in which, instead of using the aforementioned printer driver provided by the printer vendor, a printer is controlled by an OS- standard universal printing program that forms part of an operating system (OS). In this technology, when the OS detects a printer, the OS associates the printer with the OS-standard universal printing program. Thereafter, when the OS receives a print instruction for the printer, the OS-standard universal printing program generates print data without using the printer driver provided by the printer vendor, thereby enabling printing via the OS-standard universal printing program.

However, the OS-standard universal printing program does not have a sufficient configuration for printing on roll media, as has conventionally been provided by printer drivers supplied by printer vendors. As a result, the OS-standard universal printing program may not be capable of fully utilizing the capabilities of printers capable of printing on roll media.

According to an aspect of the disclosure, a non-transitory computer-readable storage medium stores a supporting program executable by a computer of an information processing apparatus. The supporting program causes the computer to perform operations including: determining whether a printer connected to the information processing apparatus supports printing on roll media in response to receiving a specified instruction from a universal printing program included in an operating system of the information processing apparatus; in response to determining that the printer supports printing on roll media, causing a user interface of the image processing apparatus to display a settings screen that accepts the setting of specific parameters for printing on roll media; and in a case where, in response to a print instruction to cause the printer to print an image being issued to the universal printing program from an application program incorporated in the information processing apparatus, image data representing the image to be printed according to the print instruction is input from the operating system, and the specific parameters are set on the setting screen, causing the printer to print on roll media based on the image data and in accordance with the specific parameters. This enables printing on roll media that fully utilizes the capabilities of the printer.

An information processing apparatus incorporating the supporting program, a control method for implementing the functions of the supporting program, and a printing system including the supporting program and a printer are also novel and useful.

### BRIEF DESCRIPTION OF THE DRAWINGS

FIG. 1 is a block diagram schematically illustrating an electrical configuration of a personal computer.

FIG. 2 is a sequence diagram illustrating an example of a print settings specifying procedure.

FIG. 3 illustrates an example of a print settings screen.

FIG. 4 illustrates an example of a long-length print settings screen.

FIG. 5 is a sequence diagram illustrating an example of a print execution procedure.

FIG. 6 illustrates an example of a preview screen.

### DESCRIPTION

Hereinafter, a personal computer ("PC") using a supporting program of an embodiment will be described in detail with reference to the accompanying drawings. The disclosure describes the supporting program executable by the PC.

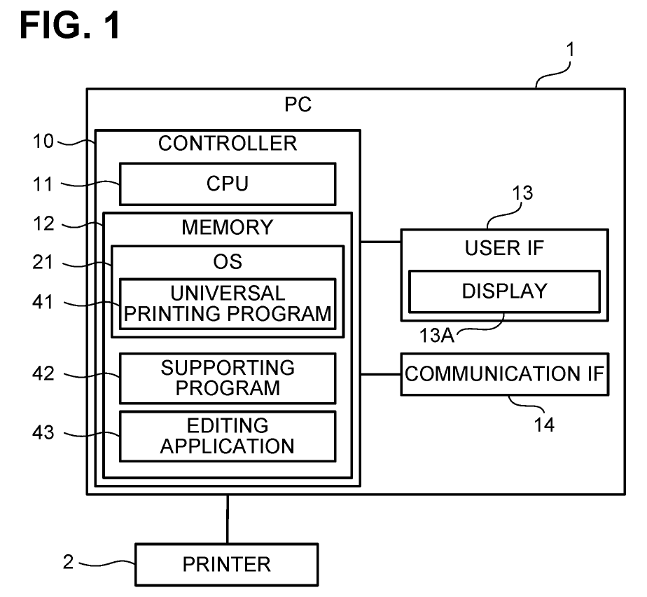

As illustrated in FIG. 1, a PC 1 of the embodiment includes a controller 10 including a CPU 11 and a memory 12. The PC 1 is an example of an information processing apparatus. The CPU 11 is an example of a computer. The PC1 includes a user interface (hereinafter, referred to as a "user IF") 13 and a communication interface (hereinafter, referred to as a "communication IF") 14, which are electrically connected to the controller 10. The term "controller 10" used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and various types of data. The memory 12 also serves as a workspace for processing. Examples of the memory 12 include a buffer included in the CPU 11. Examples of the memory 12 further include, but are not limited to a ROM, a RAM, a hard disk drive incorporated in the PC 1, and storage media that are readable and writable by the CPU 11, such as recording media including CD-ROMs and DVD-ROMs.

The user IF 13 includes a display 13a, which is hardware for displaying information to a user. Further, the user IF 13 includes hardware for user input. The user IF 13 may be a combination of the display 13a and an input device having an input reception function, such as a mouse or keyboard, or may be a touch screen having both the function of the display 13a and the input reception function.

The communication IF 14 includes hardware that enables the PC 1 to communicate with an external device such as a printer 2. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various types of data and programs, including an operating system (hereinafter, referred to as "OS") 21, a supporting program 42, and an editing application 43. The OS 21 includes a universal printing program 41. The editing application 43 is an example of an application program.

The OS 21 is a multitasking OS that manages multiple tasks and switches between the multiple tasks, thereby handling the multiple tasks simultaneously. The OS 21 may be, for example, Windows, macOS, Linux, iOS, or Android. Windows is a trademark of the Microsoft group of companies. macOS is a registered trademark of Apple Inc. Linux is a registered trademark of Linus Torvalds. iOS is a registered trademark of Cisco Systems, Inc. Android is a registered trademark of Google LLC.

The OS 21 includes the universal printing program 41. The universal printing program 41 is an OS-standard program that is developed by a vendor of the OS 21 and provided as part of the OS 21. That is, the PC 1 is equipped with the OS 21 having the universal printing program 41. The universal printing program 41 is not designed to utilize printer-specific drivers. The universal printing program 41 enables various types and models of printers provided by different vendors to perform printing based on user instructions. The universal printing program 41 supports general functions that enable various printers to perform printing. Unlike printer drivers specific to each printer, the universal printing program 41 does not support functions that are specific to each printer or printer driver, particularly those that require complicated processing.

The universal printing program 41 includes a function that, in response to a user instruction, receives image data specified as the print target in a print instruction is sued from an application and generates intermediate image data based on the image data. The intermediate image data may be, for example, data in XPS format. "XPS" is an abbreviation for XML Paper Specification. The universal printing program 41 further includes a function that generates print data in a format available for printing by various types of printers based on the intermediate image data. The print data is, for example, PWG Raster data or PDF data. The universal printing program 41 further includes a function that transmits the generated print data to a printer designated as a device for printing, using a communication function of the OS 21.

The supporting program 42 consists of a single program or a group of programs that, in association with the processing executed by the universal printing program 41, executes processing based on an instruction received from the OS 21 and supports control of target hardware. The supporting program 42 is provided for the model of the printer 2 connected to the PC 1, for example, by the vendor of the printer 2. The universal printing program 41 launches the supporting program 42 for the printer 2 based on a specific condition. Such a condition may include the designation of the printer 2 as a device for executing printing, the reception of an instruction to specify advanced print settings while the printer 2 is designated, and the reception of an instruction to cause the printer 2 to perform printing. The supporting program 42 may be referred to, for example, as a Print Support Application (abbreviated as PSA) or a Hardware Support Application (abbreviated as HSA).

In one example, the supporting program 42 may be a combination of multiple programs, each of which receives execution commands. In another example, the supporting program 42 may be a single program configured to execute different types of processing based on received commands. Supporting programs may be prepared for different types of printers by a printer vendor.

For example, when a printer is newly connected to the PC 1, the OS 21 of the PC 1 may download a supporting program appropriate for the type or model of the connected printer from a server of the vendor of the printer, and incorporate the supporting program into the PC 1. The OS 21 stores identification data of the incorporated supporting program into the memory 12 in association with printer data of the newly connected printer.

The editing application 43 is, for example, a program for creating and editing image data and document data. The editing application 43 may be, for example, Microsoft Word or Microsoft PowerPoint developed by Microsoft or may be a program provided by the vendor of the printer 2. Microsoft, and Microsoft PowerPoint are trademarks of the Microsoft group of companies. The editing application 43 can receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user request.

As illustrated in FIG. 1, the PC 1 of the present embodiment is connected to the printer 2 via the communication IF 14. The printer 2 has at least a printing function and a communication function. For example, in response to receiving print data from the PC 1, the printer 2 performs printing based on the received print data. The printer 2 may be an apparatus capable of color printing. The printer 2 may be an apparatus capable of only monochrome printing.

The following describes a procedure, performed on the PC 1 of the present embodiment, for causing the printer 2 to perform printing. Processing executed in each step in the embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms related to "obtain" are used to refer to a concept that does not necessarily require a request.

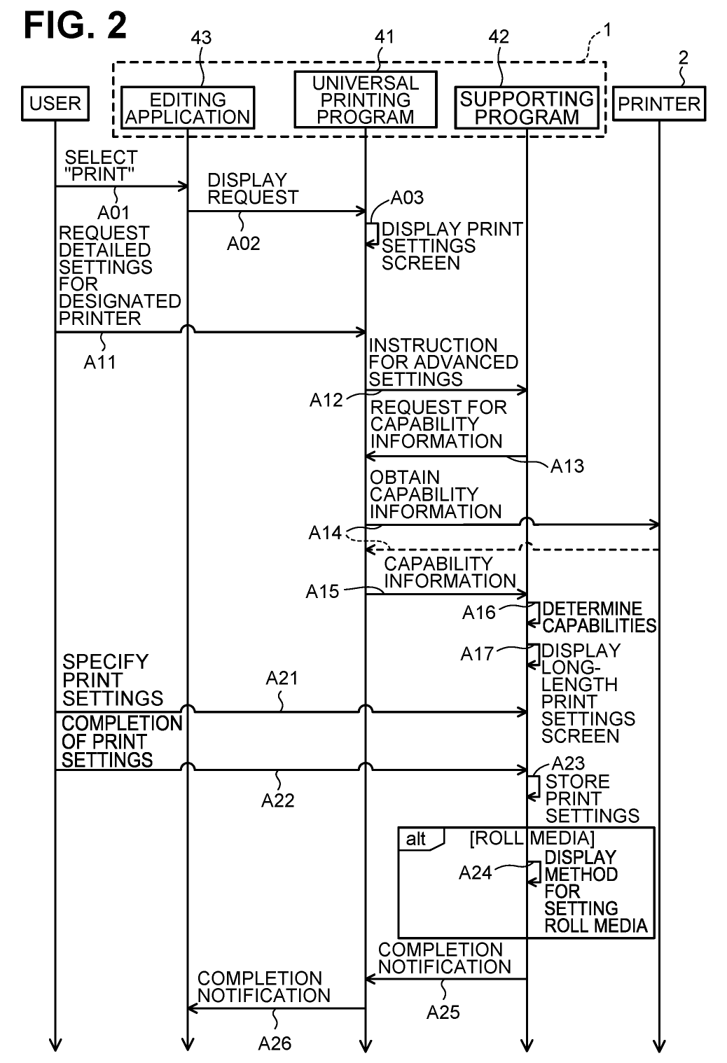

First, a print settings specifying procedure will be described with reference to FIG. 2. The editing application 43 allows the user to create and edit text and images. In a case where the user intends to print a document or image being displayed, the user selects "Print" on the editing application 43 (A01). For example, the user may select "Print" from a menu of operation items listed in the editing application 43.

In response to the user selecting "Print", the editing application 43 requests the universal printing program 41 of the OS 21 to display a screen that accepts instructions related to printing (A02). In response to the display request, the universal printing program 41 causes the user IF 13 to display a print settings screen (A03). The print settings screen accepts user instructions related to print settings that are available to the universal printing program 41. Displaying the print settings screen may be implemented by the editing application 43.

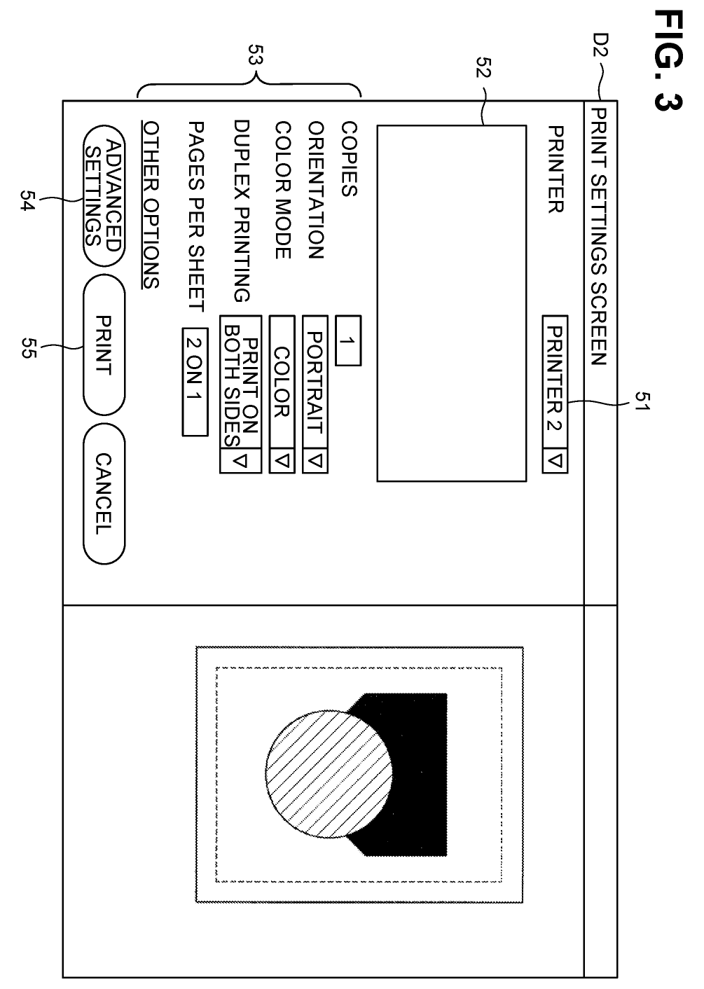

FIG. 3 illustrates an example of the print settings screen. In the example illustrated in FIG. 3, a print settings screen D2 includes a printer selection field 51, an information display field 52, basic print settings specification fields 53, an "advanced settings" button 54, and a "print" button 55. The printer selection field 51 is used to accept the designation of a device for printing. The information display field 52 displays information specified by the supporting program 42 for the device designated in the printer selection field 51. For example, in response to the designation of the printer 2 in the printer selection field 51 or in response to the reception of a print instruction via the "print" button 55 while the printer 2 is set as the default printer in the OS 21, the universal printing program 41 launches the supporting program 42 and displays an image prepared by the supporting program 42 in the information display field 52.

Each of the basic print settings specification fields 53 is used to receive an instruction for a basic setting such as the number of copies or the orientation of the document. The "advanced settings" button 54 is used to receive an instruction to configure settings that are not included in the basic print settings specification fields 53. The "print" button 55 is used to receive a print execution instruction based on currently selected print settings.

For example, when the printer 2 is designated as the device for executing printing in the printer selection field 51 and detailed print settings for the designated printer 2 are requested via operation of the "advanced settings" button 54 (A11), the universal printing program 41 passes an instruction to the supporting program 42 for the printer 2 to start allowing the user to specify the advanced print settings (A12).

After the supporting program 42 is launched in response to receiving the instruction in A12, the supporting program 42 obtains capability information of the printer 2. More specifically, the supporting program 42 requests the universal printing program 41 to obtain the capability information (A13). In response to receiving the request, the universal printing program 41 transmits a command that requests capability information to the printer 2, and obtains the capability information from the printer 2 (A14). The universal printing program 41 then passes the obtained capability information to the supporting program 42 (A15). The supporting program 42 thus obtains the capability information of the printer 2. In A14, the universal printing program 41 performs communication with the printer 2 via the OS 21 in accordance with, for example, the Internet Printing Protocol (abbreviated as IPP). The supporting program 42 may obtain the capability information directly from the printer 2 using, for example, the Management Information Base (abbreviated as MIB), instead of obtaining the capability information via the universal printing program 41. The capability information obtainable from the printer 2 includes information on parameters that are settable as print settings, as well as whether printing on roll media is possible. The capability information may further include, for example, remaining life of consumables, available trays, sheet sizes assigned to trays, and available print resolutions. The printer 2 may have a function of performing image processing based on a received print job and printing using image data obtained from the image processing. The printing enabled by this function may be, for example, consolidated printing such as N-in-one printing, embedded printing such as printing with a watermark, or colorant saving printing. In a case where the printer 2 has an image processing function that can be performed by the printer 2 itself, the printer 2 may pass capability information including information on the function to the universal printing program 41 or the supporting

In A14, the universal printing program 41 performs communication with the printer 2 via the OS 21 in accordance with, for example, the Internet Printing Protocol (abbreviated as IPP). The supporting program 42 may obtain the capability information directly from the printer 2 using, for example, the Management Information Base (abbreviated as MIB), instead of obtaining the capability information via the universal printing program 41.

The capability information obtainable from the printer 2 includes information on parameters that are settable as print settings, as well as whether printing on roll media is possible. The capability information may further include, for example, remaining life of consumables, available trays, sheet sizes assigned to trays, and available print resolutions. The printer 2 may have a function of performing image processing based on a received print job and printing using image data obtained from the image processing. The printing enabled by this function may be, for example, consolidated printing such as N-in-one printing, embedded printing such as printing with a watermark, or colorant saving printing. In a case where the printer 2 has an image processing function that can be performed by the printer 2 itself, the printer 2 may pass capability information including information on the function to the universal printing program 41 or the supporting program 42. The printer 2 may pass capability information including a status of the printer 2 to the universal printing program 41 or the supporting program 42.

The supporting program 42 determines whether the printer 2 supports printing on roll media. The roll media refers to a long, continuous print medium of a specified width that is wound into a roll. A16 is an example of determining whether the printer supports printing on roll media. A16 is executed in response to the instruction from the universal printing program 41 in A12. A12 is an example of a specified instruction.

The supporting program 42 obtains, for example, tray information indicating a feed tray included in the printer 2 as part of the capability information of the printer 2. When the tray information includes information indicating a feed tray that supports roll media, the supporting program 42 determines in A16 that the printer 2 supports roll media. A15, which is used to obtain tray information as capability information, is an example of obtaining tray information. The feed tray that supports roll media may be a tray dedicated to roll media, or may support both roll media and cut sheets.

The supporting program 42 obtains, as the capability information of the printer 2, for example, media type information indicating the type of media intended or detected for each feed tray of the printer 2. When the media type information includes a type of media corresponding to roll media, the supporting program 42 determines in A16 that the printer 2 supports roll media. A15, which is used to obtain media type information as the capability information, is an example of obtaining media type information. Examples of types of media corresponding to roll media include roll paper, label rolls, and fabric rolls.

The supporting program 42 obtains, as the capability information of the printer 2, for example, media size information indicating the size of media set or detected for each feed tray of the printer 2. When the media size information includes a size of media corresponding to roll media, the supporting program 42 determines in A16 that the printer 2 supports roll media. A15, which is used to obtain media type information as the capability information, is an example of obtaining media type information. Examples of media sizes corresponding to roll media include indefinite length and user-defined sizes. The supporting program 42 may, for example, determine that the printer 2 supports roll media when the user-defined size information includes a media size in which the ratio of the long side to the short side exceeds a predetermined value.

The printer 2 is regarded as supporting the roll media when the printer 2 has a function to perform printing while feeding roll media, regardless of whether roll media is actually set in the printer 2. The following describes a case where the printer 2 supports roll media.

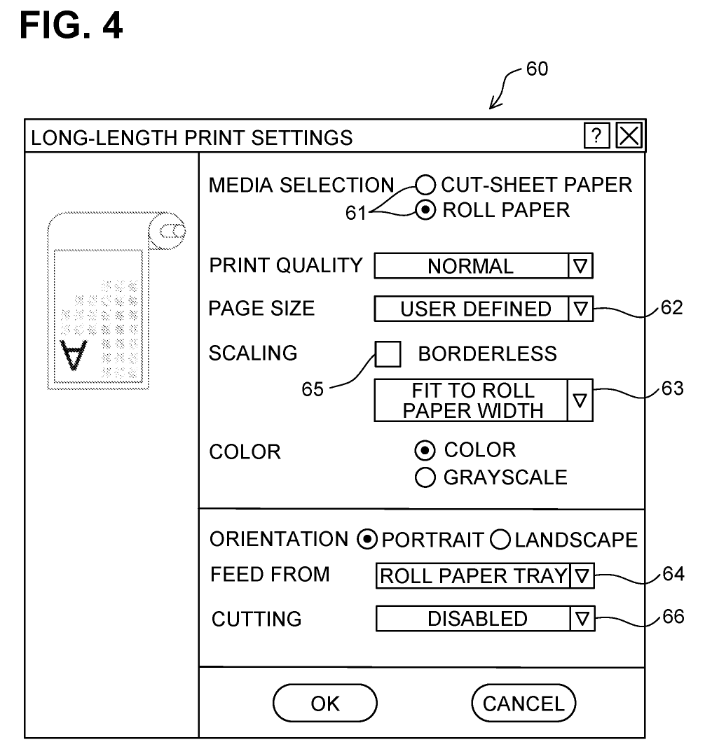

When the supporting program 42 determines in A16 that the printer 2 supports printing on roll media, the supporting program 42 causes the user IF 13 to display, as a screen for accepting detailed print settings, an advanced settings screen for accepting parameters related to printing on roll media, for example, a long-length print settings screen 60 as illustrated in FIG. 4 (A17). A17 is an example of causing a user interface of the image processing apparatus to display a settings screen that accepts the setting of specific parameters for printing on roll media. The long-length print settings screen 60 is an example of a settings screen. The advanced settings screen displayed by the supporting program 42 includes parameters as options that the printer 2 supports. The supporting program 42 accepts user operations on the currently displayed advanced settings screen. The advanced settings screen, which includes a relatively large number of print setting items, may have multiple tabs, with each tab corresponding to a different category of print settings. The supporting program 42 may accept instructions to switch between selectable items via multiple tabs. The long-length print settings screen 60 illustrated in FIG. 4 includes, for example, a paper selection button 61 that accepts a mutually exclusive selection between "cut-sheet paper" and "roll paper", a selection field 62 that accepts the selections of a "user defined" size, and a selection field 64 that accepts the selection of a "roll paper tray". Setting the paper selection button 61 to "roll paper", setting the "user defined" size in the selection field 62, and setting the "roll paper tray" in the selection field 64 are all parameter settings related to printing on roll media, and are examples of setting specific parameters.

The advanced settings screen, which includes a relatively large number of print setting items, may have multiple tabs, with each tab corresponding to a different category of print settings. The supporting program 42 may accept instructions to switch between selectable items via multiple tabs.

The long-length print settings screen 60 illustrated in FIG. 4 includes, for example, a paper selection button 61 that accepts a mutually exclusive selection between "cut-sheet paper" and "roll paper", a selection field 62 that accepts the selections of a "user defined" size, and a selection field 64 that accepts the selection of a "roll paper tray". Setting the paper selection button 61 to "roll paper", setting the "user defined" size in the selection field 62, and setting the "roll paper tray" in the selection field 64 are all parameter settings related to printing on roll media, and are examples of setting specific parameters.

For example, when at least one of "roll paper", "user defined" size, and "roll paper tray" illustrated in FIG. 4 is selected, the supporting program 42 enables the other parameters among these to be specified. Further, when at least one of "roll paper", "user defined" size, and "roll paper tray" is selected, for example, the supporting program 42 may display an option of "fit to roll paper width" in the scaling selection field 63 in a selectable manner. The "fit to roll paper width" setting in the selection field 63 is an example of the setting of specific parameters for printing on roll media.

The option "fit to roll paper width" in the selection field 63 is an option for accepting a selection as to whether the image to be printed is scaled up or down to fit the width of the roll media in the printing procedure described later. That is, in response to receiving a print execution instruction in a state where "fit to roll paper width" is selected in the selection field 63, the supporting program 42 causes the printer 2 to print an image scaled up or down to fit the width of the roll media. The "fit to roll paper width" setting is an example of a setting for enabling or disabling a scaling option.

When the paper selection button 61 is set to "roll paper", the supporting program 42 may display "fit to roll paper width" as the default option in the selection field 63 and "roll paper tray "as the default option in the selection field 64 on the long-length print settings screen 60.

In contrast, when the supporting program 42 determines that the printer 2 does not support roll media, the supporting program 42 causes, in A17, the user IF 13 to display an advanced settings screen in which parameters related to printing on roll media are unavailable. The supporting program 42 may display a long-length print settings screen 60 that does not include the options "roll paper", "user defined" size, and "roll paper tray". Alternatively, the supporting program 42 may display these options in a non-selectable manner. The supporting program 42 may also display an advanced settings screen different from the long-length print settings screen 60.

Even if the printer 2 has the function to print on roll media, if the printer 2 does not include a feed tray that supports roll media, the supporting program 42 may be configured not to accept the setting of parameters related to printing on roll media. Further, even after the paper selection button 61 is set to "roll paper", if the feed tray that does not support roll media is selected in the selection field 64, the supporting program 42 may automatically change the setting state of the paper selection button 61 to "cut-sheet paper".

Further, the printer 2 may have a borderless printing function. When the printer 2 has a borderless printing function, the supporting program 42 may accept a borderless printing instruction. The supporting program 42 may display, for example, the long-length print settings screen 60, as illustrated in FIG. 4, which includes a checkbox 65 for selecting between borderless printing and bordered printing.

Further, the printer 2 may have specific functions that perform particular processing on a roll medium after printing. For example, the printer 2 may include a cutter that cuts the roll media, and may have a cutting function for cutting and discharging printed portions. When the printer 2 has the cutting function, the supporting program 42 may display, for example, the long-length print settings screen 60, as illustrated in FIG. 4, which includes an option 66 for receiving a setting related to the cutting function. The supporting program 42 may accept a selection of one of, for example, cutting after printing all pages, cutting after printing each page, and not cutting at all, at the option 66. When the printer 2 has a half-cut function (or a partial cut function) for partially cutting the media while leaving a portion uncut, the supporting program 42 may accept a selection of the half-cut function.

The printer 2 may have a feed function that, after printing, feeds the roll media until the printed portion protrudes from the housing of the printer 2 to the outside. When the printer 2 has a feed function, the supporting program 42 may accept a selection of whether to use the feed function. When the printer 2 does not have the cut function or the feed function, the supporting program 42 may not accept the settings related to these functions, or may display a warning when the settings are accepted.

The supporting program 42 receives various setting instructions related to printing on the displayed advanced settings screen such as the long-length print settings screen 60 (A21). The user can then issue an instruction to complete the print settings by operating the OK button on the advanced settings screen such as the long-length print settings screen 60. When the supporting program 42 receives an instruction from the user to complete the print settings (A22), the supporting program 42 terminates the display of the advanced settings screen and stores information of the received print settings (A23).

When the supporting program 42 receives an instruction to complete the print settings while having accepted print settings indicating printing on the roll media (alt: [ROLL MEDIA]), the supporting program 42 causes the user IF 13 to output, for example, by displaying, instructions for the roll media setting method (A24). The supporting program 42 outputs instructions for the setting method, for example, via a procedure screen, an instructional video, or an instructional message. A24 is an example of causing the user interface of the information processing apparatus to output instructions for a roll medium setting method. If an instruction to print on roll media is received without the roll media properly set in the feed tray, a feed error may easily occur in printer 2. When parameters indicating printing on the roll media are set, the supporting program 42 also outputs instructions for the roll media setting method, enabling the user to print roll media with the printer 2.

The roll media setting method may differ depending on the model of the printer 2 and the type of feed tray set in the printer 2. The supporting program 42 outputs, based on the capability information obtained in A15 and information on the feed tray selected in the accepted print settings, instructions for a setting method corresponding to the feed tray. The supporting program 42 may have information in advance about the setting methods for each type of feed tray that is attachable to the model of printer 2, and may select a corresponding setting method and output instructions for the corresponding setting method. Further, the supporting program 42 may provide a link to a web page prepared by the vendor of printer 2 that explains how to set the roll media, or may open a browser to display the web page.

The timing for providing instruction for the setting method is not limited to the completion of print settings. For example, when a parameter indicating printing on roll media is selected on the long-length print settings screen 60, or when an instruction to apply a parameter indicating printing on roll media is received, the supporting program 42 may output instructions for a roll media setting method. Further, when the supporting program 42 outputs instruction for the setting method while displaying the print settings screen such as the long-length print settings screen 60, the supporting program 42 may display the setting method included in the print settings screen being currently displayed.

Further, the supporting program 42 may accept instructions to modify the print settings again on the screen that displays the roll media setting method. Upon receiving such an instruction to modify the settings again, the supporting program 42 proceeds to A17 and displays the detailed print settings screen again. In addition, the supporting program 42 may accept an instruction, on the screen that displays the roll media setting method, to hide this information in the future.

Then, the supporting program 42 notifies the universal printing program 41 of the completion of accepting detailed print settings (A25). The universal printing program 41 notifies the editing application 43 of the completion of print settings based on the notification from the supporting program 42 (A26). The supporting program 42 may notify the editing application 43 of the completion of accepting the print settings. The editing application 43 activates the print settings screen (for example, the print settings screen D2 illustrated in FIG. 3) displayed in A03, so that the print settings screen becomes ready to accept user instructions such as instructions to execute or cancel printing.

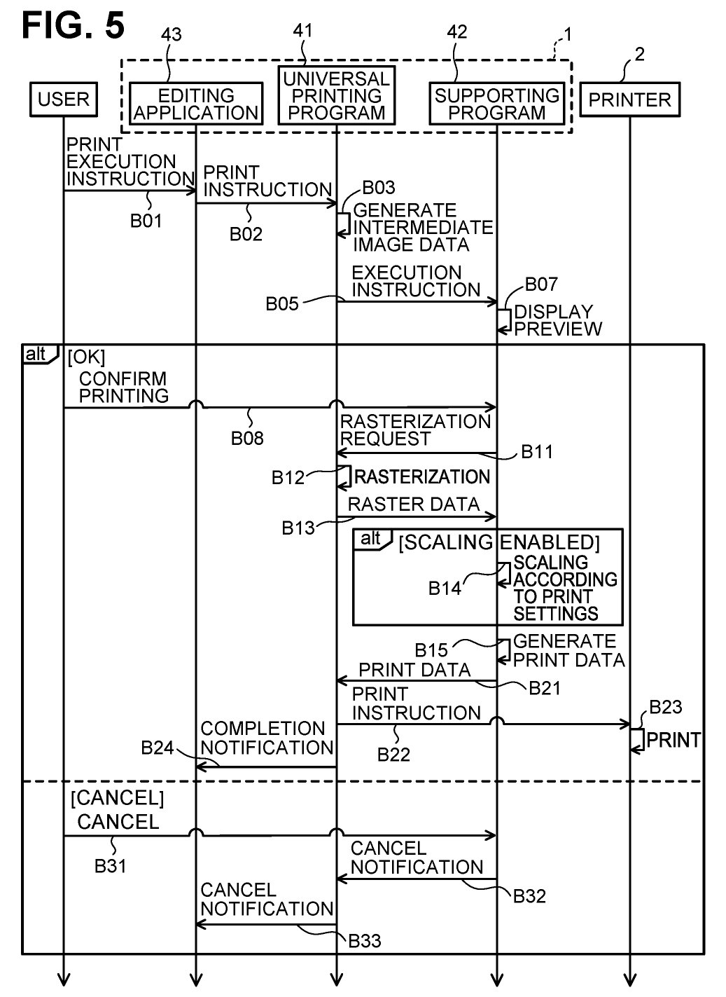

As described above, the print settings screen D2 (refer to FIG. 3) includes the information display field 52 capable of displaying an image prepared by the supporting program 42. In response to receiving an operation in the information display field 52, the universal printing program 41 passes information regarding the operation to the supporting program 42. The supporting program 42 causes, for example, an information screen that accepts print instructions on roll media to be displayed in the information display field 52, thereby accepting such print instructions on roll media based on user instructions in the information display field 52. The supporting program 42 can accept print settings including print instructions on the roll media even when the print settings are accepted via the information display field 52. The following describes a print execution procedure with reference to FIG. 5. After finalizing the image to be printed and the print settings for the printer 2, the user issues a print execution instruction via the editing application 43 (BO1). For example, when the editing application 43 receives an operation on the "print" button 55 in the print settings screen D2 of FIG. 3, the editing application 43 determines that it has received an execution instruction instructing the universal printing program 41 to cause the printer 2 to print the currently selected image. The editing application 43 passes the details of the print execution instruction to the universal printing program 41 (B02). The universal printing program 41 thus obtains image data representing the image to be printed and the print settings, as the details of the print execution instruction, from the editing application 43.

The following describes a print execution procedure with reference to FIG. 5. After finalizing the image to be printed and the print settings for the printer 2, the user issues a print execution instruction via the editing application 43 (BO1). For example, when the editing application 43 receives an operation on the "print" button 55 in the print settings screen D2 of FIG. 3, the editing application 43 determines that it has received an execution instruction instructing the universal printing program 41 to cause the printer 2 to print the currently selected image.

The editing application 43 passes the details of the print execution instruction to the universal printing program 41 (B02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (B03). The image data included in the editing application 43 is of various types. The universal printing program 41 thus converts image data representing the image to be printed into intermediate image data suitable for generating print data. When the received image data is in a suitable format, the generation of intermediate image data may be omitted, and the image data may be used as intermediate image data as is, without conversion.

Before generating the intermediate image data, the universal printing program 41 may launch the supporting program 42 corresponding to the printer 2, which is the designated device, and notify the supporting program 42 that the processing of the print job has begun. When the supporting program 42 is launched by the universal printing program 41, the supporting program 42 is allowed to pass information indicating various instructions to be used when the intermediate image data is generated, to the universal printing program 41, as necessary.

After generating the intermediate image, the universal printing program 41 launches the supporting program 42 (B05). The supporting program 42 can obtain the intermediate image data generated by the universal printing program 41 by making a request to the universal printing program 41. The supporting program 42 can edit the intermediate image data and print setting information received from the universal printing program 41 based on the print settings stored in A23 of Fig. 2 .

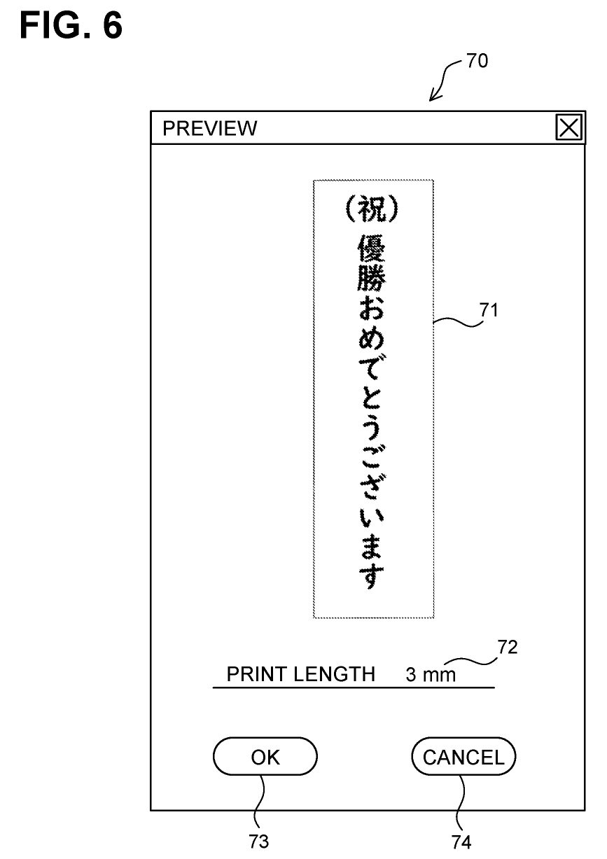

The supporting program 42 causes the user IF 13 to display, for example, a preview screen 70 including a preview image 71 as illustrated in FIG. 6, based on the intermediate image data received from the universal printing program 41 and the print settings stored in A23 (B07). B07 is an example of causing the user interface to display a preview image. The preview screen 70 illustrated in FIG. 6 includes a print length information field 72, an OK button 73, and a Cancel button 74. The supporting program 42 displays the preview screen 70 including the preview image 71 before printing on roll media, allowing the user to easily imagine how the printout will look. For example, when a print instruction indicates printing on roll media, the user may find it difficult to determine the length of the printout. The supporting program 42 outputs, for example, the length of the printout in the feeding direction of the roll media as a numerical value in the print length information field 72 of the preview screen 70, which is displayed at B07. The supporting program 42 displays the length on the preview screen 70, thereby allowing the user to grasp the image of the printout more concretely. The supporting program 42 may display the width of the roll media in addition to the length of the printout. The supporting program 42 may rasterize intermediate image data to generate the preview image 71 for display. In this case, the supporting program 42 may perform rasterization at the same resolution as used for printing, or at a lower resolution. When an image rasterized at a

For example, when a print instruction indicates printing on roll media, the user may find it difficult to determine the length of the printout. The supporting program 42 outputs, for example, the length of the printout in the feeding direction of the roll media as a numerical value in the print length information field 72 of the preview screen 70, which is displayed at B07. The supporting program 42 displays the length on the preview screen 70, thereby allowing the user to grasp the image of the printout more concretely. The supporting program 42 may display the width of the roll media in addition to the length of the printout.

The supporting program 42 may rasterize intermediate image data to generate the preview image 71 for display. In this case, the supporting program 42 may perform rasterization at the same resolution as used for printing, or at a lower resolution. When an image rasterized at a lower resolution is displayed as the preview image 71, the supporting program 42 may display information indicating that the image is being displayed at a lower resolution.

The supporting program 42 accepts, on the displayed preview screen 70, an instruction from the user, which is either an instruction to confirm printing by operating the OK button 73 or an instruction to cancel printing by operating the Cancel button 74. The supporting program 42 may accept instructions to modify the print settings.

When the supporting program 42 accepts an instruction to confirm printing via operation of the OK button 73 (alt: [OK], B08), the supporting program 42 passes the intermediate image to the universal printing program 41 and requests the universal printing program 41 to rasterize the intermediate image (B11). The universal printing program 41 rasterizes the intermediate image to generate raster data, which is bitmap data (B12). Further, the universal printing program 41 passes the generated raster data to the supporting program 42 (B13). The supporting program 42 thus obtains the raster data.

Instead of the universal printing program 41, the supporting program 42 may perform rasterization. In this case, the supporting program 42 performs rasterization based on the intermediate image data received in response to the print execution instruction, and generates raster data. The supporting program 42 may provide greater flexibility in rasterization than the universal printing program 41, which is likely to result in raster data that is suitable for printing by the printer 2. However, rasterization by the universal printing program 41 may enable the supporting program 42 to execute less processing, thus reducing the size of the supporting program 42.

When the print settings include scaling (alt: [SCALING]), the supporting program 42 scales the received raster data up or down according to the print settings (B 14). B14 is an example of scaling the image up or down. For example, when "fit to roll paper width" is set in the selection field 63 on the long-length print settings screen 60 illustrated in FIG. 4, the supporting program 42 scales the raster data up or down so that the size of the raster data in the main scanning direction matches the width of the roll media. Since the supporting program 42 can enlarge or reduce the image based on the width of the roll media, printing suitable for the roll media can be performed.

When the printer 2 has the borderless printing function, the supporting program 42 changes the width of the roll media used for scaling in B14 based on the setting accepted in the checkbox 65 of the long-length print settings screen 60 illustrated in FIG. 4. That is, the supporting program 42 determines a scaling factor based on the accepted print setting that indicates whether borderless or bordered printing is selected.

The supporting program 42 may pass a scaling factor and raster data to the universal printing program 41 to have the universal printing program 41 scale the raster data up or down. If the printer 2 has a scaling function, scaling can be delegated to the printer 2. The supporting program 42 may transmit a command indicating scaling to the printer 2, or may generate print data including information indicating scaling at the time of generation of the print data to be described later. However, if the supporting program 42 performs scaling, the processing load of the printer 2 is reduced.

The supporting program 42 then encodes the raster data obtained in B13 or B14 into PDL data to generate print data (B15). The supporting program 42 may process the raster data as necessary before generating the print data.

When the print settings include a setting for enabling a specific function of the printer 2, the supporting program 42 generates, in B15, print data incorporating a command indicating an instruction related to the specific function. For example, when selection of the cutting function is accepted as print settings, the supporting program 42 incorporates a command indicating the cutting function into the print data. When selection of the feed function is accepted as print settings, the supporting program 42 incorporates a command indicating the feed function into the print data. Each of the command indicating the cutting function and the command indicating the feed function is an example of a specific command.

The supporting program 42 passes the generated print data to the universal printing program 41 and instructs the universal printing program 41 to transmit the print data to the printer 2 (B21). B21 is a step for causing the printer 2 to print based on image data. B21, in a case where a command indicating the function of the printer 2 is incorporated in the print data and then passed to the universal printing program 41, is an example of a step of transmitting a specific command to the printer 2. Since the supporting program 42 can transmit the command instructing the execution of the specific processing executable by the printer 2 to the printer 2, the function of the printer 2 can be utilized.

The print data that the supporting program 42 passes to the universal printing program 41 in B21 may be in any format printable by the printer 2. The PDL data generated by the supporting program 42 may be in a format that can also be used for printing on printers other than the model of the printer 2.

In response to the instruction from the supporting program 42, the universal printing program 41 transmits the print data to the printer 2 and instructs the printer 2 to perform printing (B22). The printer 2 performs printing based on the received print data (B23). When the printer 2 receives print data indicating printing on roll media, the printer 2 performs printing while feeding the roll media. When a command instructing execution of the particular process is incorporated in the print data, the printer 2 performs the particular process on a roll medium after printing in accordance with the command. This results in the generation of a printout based on the print instruction output from the editing application 43. After B22, the universal printing program 41 notifies the editing application 43 of the completion of the processing (B24).

In B21 of FIG. 5, the supporting program 42 passes the print data to the universal printing program 41, which then transmits it to the printer 2. Instead, the supporting program 42 may transmit, to the printer 2, both the print data and a print command instructing execution of printing. For example, when a setting related to image processing executable by the printer 2 is included as a print setting, the supporting program 42 may generate a print command including information of the processing. In this case, after completing the transmission of the print data, the supporting program 42 may notify the universal printing program 41 of the completion of the print data transmission.

In contrast, when the supporting program 42 accepts an instruction to cancel printing via an operation of the Cancel button 74 on the preview screen 70 displayed in B07 (alt: [CANCEL], B31), the supporting program 42 does not perform the rasterization request or the print data generation. The supporting program 42 notifies the universal printing program 41 of the cancellation of printing (B32). The universal printing program 41 notifies the editing application 43 of the cancellation of printing (B33). In this case, the print data is not transmitted to the printer 2, and no printout is produced.

As described above in detail, in a case where the printer 2 supports printing on roll media, the supporting program 42 of the present embodiment displays a settings screen that accepts parameter setting for printing on roll media, for example, the long-length print settings screen 60 (refer to FIG. 4). The supporting program 42 accepts parameter settings for printing on roll media via the settings screen. In a case where, in response to a print instruction to cause the printer 2 to print an image being issued to the universal printing program 41, intermediate print data representing the image to be printed is input from the OS 21, the supporting program 42 causes the printer 2 to print according to the parameters for printing on roll media. This enables printing on roll media that fully utilizes the capabilities of the printer 2.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. The number of printers to be connected to the PC 1 is not limited to the illustrated example; two or more printers may be connected.

In addition, the screens to be displayed on the user IF 13 are all examples, and are not limited to the illustrated examples. The words, object shapes, and screen backgrounds shown in the illustrated screens and screen layouts are all examples. For example, FIG. 3 illustrates the print settings screen D2 including a single information display field 52. Nevertheless, the location, shape, and size of the information display field 52, and the number of information display fields 52 are not limited to the example illustrated. The information display field 52 may be omitted.

In this specification, the settings of "roll paper", "user defined" size, and "roll paper tray" have been exemplified as parameters related to printing on roll media. However, the number of options and expressions are not limited to this example. The supporting program 42, for example, may accept a setting for selecting a specific type of roll media, or may accept a parameter related to printing on roll media when the roll media is set in the printer 2.

In the present embodiment, the supporting program 42 performs a preview display when it has accepted a print setting indicating printing on roll media; however, the preview display does not necessarily have to be performed. For example, the supporting program 42 may accept a setting as to whether to perform a preview display. In the present embodiment, an instruction to cancel printing can be accepted via the preview display; however, accepting such an instruction is not required. Further, although the length of the printout is displayed as a numerical value in the preview display, the display of the numerical value may be omitted.

In the present embodiment, the supporting program 42 accepts the settings related to the functions of the printer 2, but does not necessarily have to accept the settings. For example, an instruction for the cut function or feed function may be accepted after printing via an operation panel of the printer 2.

The timing at which the supporting program 42 obtains the capability information of the printer 2 is not limited to the example illustrated in FIG. 2. For example, in a case where the supporting program 42 is launched by the universal printing program 41 before the print settings screen D2 (refer to FIG. 3) is displayed, the supporting program 42 may request the capability information of the printer 2. The supporting program 42 may obtain the capability information of the printer 2 again after receiving the print execution instruction.

For example, the universal printing program 41 may also launch the supporting program 42 if the default printer is changed to the printer 2 via the OS 21 by a user's operation after the universal printing program 41 displays the print settings screen D2. In this case, the supporting program 42 may display, in the information display field 52, an information screen that accepts instructions related to printing on roll media.

The supporting program 42 may be launched not only when the "Print" button is selected but also when the printer 2 is specified as the device settings, for example. In this case, the supporting program 42 may display a settings screen that accepts instructions to set roll media as the default media.

In the present embodiment, the description has been provided only for the printing operation in which the supporting program 42 is involved. However, the supporting program 42 may be involved in operations other than the printing operation. The program that executes the processing of the present embodiment is not limited to the supporting program 42, but may be any program that can accept instructions from the OS 21 or the universal printing program 41 when performing printing using the universal printing program 41. For example, a print workflow application (Print Workflow) for which the specifications have been disclosed by Microsoft Corporation may be used.

The execution timing of the supporting program 42 is not limited to the examples of the present embodiment. For example, the supporting program 42 may be executed upon receiving a direct execution instruction from the OS 21. Alternatively, the supporting program 42 may be a resident program. When the supporting program 42 is resident, the supporting program 42 may perform the above-described operations in response to an execution instruction.

In any sequence diagram disclosed in the present embodiment, steps may be executed in a different order or in parallel, provided no inconsistency arises in the contents of the procedures.

The processing in all steps disclosed in the present embodiment may be executed by hardware, such as a single CPU, multiple CPUs, an ASIC, or a combination thereof. The processing in all steps disclosed in the embodiment may be implemented in various forms, such as a recording medium storing a computer-readable program for executing the processing, or as a method.

While the disclosure has been described in detail with reference to the specific embodiment thereof, this is merely an example, and various changes, arrangements and modifications may be applied therein without departing from the spirit and scope of the disclosure.

What is claimed is:

1. A non-transitory computer-readable storage medium storing a supporting program executable by a computer of an information processing apparatus, the supporting program causing the computer to perform operations comprising:
determining whether a printer connected to the information processing apparatus supports printing on roll media in response to receiving a specified instruction from a universal printing program included in an operating system of the information processing apparatus;
in response to determining that the printer supports printing on roll media, causing a user interface of the image processing apparatus to display a settings screen that accepts the setting of specific parameters for printing on roll media; and
in a case where, in response to a print instruction to cause the printer to print an image being issued to the universal printing program from an application program incorporated in the information processing apparatus, image data representing the image to be printed according to the print instruction is input from the operating system, and the specific parameters are set on the setting screen, causing the printer to print on roll media based on the image data and in accordance with the specific parameters.

2. The non-transitory computer-readable storage medium according to claim 1,
wherein the supporting program causes the computer to perform operations further comprising obtaining tray information indicating a feed tray of the printer in response to receiving the specified instruction from the universal printing program, and
wherein the determining determines that the printer supports printing on roll media in a case where, based on the tray information obtained in the obtaining, the printer includes a feed tray that supports roll media.

3. The non-transitory computer-readable storage medium according to claim 1,
wherein the supporting program causes the computer to perform operations further comprising obtaining media type information indicating a type of media intended for a feed tray of the printer in response to receiving the specified instruction from the universal printing program, and
wherein the determining determines that the printer supports printing on roll media in a case where, based on the media type information obtained in the obtaining, a type of media intended for the feed tray of the printer includes a type corresponding to roll media.

4. The non-transitory computer-readable storage medium according to claim 1,
wherein the supporting program causes the computer to perform operations further comprising obtaining media size information indicating a size of media set for a feed tray of the printer in response to receiving the specified instruction from the universal printing program, and
wherein the determining determines that the printer supports printing on roll media in a case where, based on the media size information obtained in the obtaining, a size of media set for the feed tray of the printer includes a size corresponding to roll media.

5. The non-transitory computer-readable storage medium according to claim 1, wherein the supporting program causes the computer to perform operations further comprising causing the user interface to output instructions for a roll medium setting method in response to accepting the setting of the specific parameters via the settings screen.

6. The non-transitory computer-readable storage medium according to claim 5, wherein the causing the user interface to output instructions for a roll medium setting method causes the user interface to output instructions for a roll medium setting method corresponding to a feed tray of the printer.

7. The non-transitory computer-readable storage medium according to claim 1,
wherein the specific parameters settable via the settings screen include a setting to enable or disable a scaling option for scaling an image to be printed up or down according to a width of a roll medium, and
wherein, in a case where the scaling option is enabled on the settings screen, the causing the printer to print on roll media based on the image data and in accordance with the specific parameters includes causing the image to be scaled up or down according to the width of a specified roll medium.

8. The non-transitory computer-readable storage medium according to claim 7, wherein the causing the printer to print on roll media scales the image up or down according to the width of the specified roll medium.

9. The non-transitory computer-readable storage medium according to claim 1, wherein the supporting program causes the computer to perform operations further comprising causing the user interface to display a preview image based on the image to be printed in a case where, in response to the print instruction being issued to the universal printing program, the image data representing the image to be printed according to the print instruction is input from the operating system, and the specific parameters are set on the settings screen.

10. The non-transitory computer-readable storage medium according to claim 9, wherein the causing the user interface to display a preview image further includes displaying a length of the image.

11. The non-transitory computer-readable storage medium according to claim 1,
wherein the specific parameters settable via the settings screen include a setting to enable or disable a specific function of the printer to perform a particular process on a roll medium after printing,
wherein, in a case where the specific function of the printer is enabled on the settings screen, the causing the printer to print on roll media based on the image data and in accordance with the specific parameters includes transmitting, to the printer, a specific command to control the printer, and
wherein, in response to receiving the specific command, the printer performs the particular process on a roll medium after printing.
